(19) United States
(12) Patent Application Publication
(10) Pub. No.: US 2010/0128189 A1
(43) Pub. Date: May 27, 2010

(54) DISPLAY DEVICE, METHOD FOR DRIVING THE SAME, AND ELECTRONIC DEVICE

(75) Inventors: Yasuyuki Teranishi, Kanagawa (JP); Daisuke Takama, Kanagawa (JP); Amane Higashi, Kanagawa (JP); Shiichiro Sarai, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/623,040

(22) Filed: Nov. 20, 2009

(30) Foreign Application Priority Data
Nov. 21, 2008 (JP) 2008-297720

(51) Int. Cl. G02F 1/133; G02F 1/1343

(52) U.S. Cl. 349/33; 349/141

(57) ABSTRACT

A display device includes a plurality of pixel electrodes, a first common electrode arranged on an insulation layer which covers the plurality of pixel electrodes, the first common electrode being a comb-like electrode, and a second common electrode placed opposite the first common electrode across a liquid crystal layer, the second common electrode being voltage-controlled independently of the first common electrode.

### BACKGROUND OF THE INVENTION

1. Field of the Invention

The invention relates to a display device, a method for driving a display device, and an electronic device. In addition, the invention relates to a display device which is able to perform switching between display modes, a method for driving the display device, and an electronic device including the display device.

2. Description of the Related Art

Recently, in electronic devices including a display device, portability has been improved by reduction of size and weight. For such an electronic device with better portability, it is desirable to cut off a viewing angle of anyone else close to its user by using a display function in a narrow viewing angle mode in a public place while usually using a display function in a wide viewing angle mode. Therefore, a display device capable of performing switching between viewing angle modes during display has been proposed.

For example, a configuration has been proposed in which a liquid crystal layer used as video displaying means, a liquid crystal layer used as display-mode switching means, first polarizing means including a reflection-type polarizing plate, a liquid crystal layer used as display-mode switching means, and second polarizing means are arranged in layers in this order. The configuration may realize a display device capable of concealing a displayed image from being viewed in a specific direction while retaining display quality (see, for example, International Publication No. WO2006/030702).

In addition, for a display device with IPS (In-Plane-Switching) mode using a lateral electric field, there is proposed a configuration that a plurality of image driving regions and a viewing angle adjusting region are arranged in a subpixel and switching between viewing angle modes is performed by controlling an electrode provided in the viewing angle adjusting region (see, for example, Japanese Unexamined Patent Application Publication No. 2008-9359).

### SUMMARY OF THE INVENTION

However, in a display device including a plurality of liquid crystal layers used as display-mode switching means arranged in layers, since the number of parts is large and the device configuration is complicated, thinning of the device is constricted.

In addition, in a display device including a viewing angle adjusting region arranged separately from an image driving region, since a pixel aperture is narrowed by the area of the viewing angle adjusting region, displaying a high-definition image is constricted.

According to an embodiment of the invention, it is desirable to provide a display device capable of performing switching between display modes, a method for driving the display device, and an electronic device including the display device while a high-definition image is displayed with no device configuration complicated.

According to an embodiment of the invention, in a display device, a pixel electrode and a common electrode are arranged at one side of a liquid crystal layer. Furthermore, another common electrode is arranged at the other side of the liquid crystal layer. Namely, a first common electrode which is a comb-like electrode is arranged on an insulation layer which covers a plurality of pixel electrodes. Furthermore, a second common electrode which is voltage-controlled independently of the first common electrode is placed opposite the first common electrode across a liquid crystal layer. In addition, according to an embodiment of the invention, an electronic device includes the display device.

In the display device with the aforementioned configuration, an electric field (lateral electric field) which is parallel to an electrode plane of the first common electrode is produced between the pixel electrode and the first common electrode by setting a difference of electrical potential between the pixel electrode and the first common electrode which are arranged at one side of the liquid crystal layer. Then, a display function is performed by controlling the liquid crystal layer with the lateral electric field turned on and off. On the other hand, an electric field (vertical electric field) which is perpendicular to the electrode plane of the first common electrode is produced by applying a voltage to the second common electrode placed opposite the first common electrode across a liquid crystal layer. Then, the vertical electric field is added to the lateral electric field. Therefore, a display function with switching between display modes is performed by giving an effect of the vertical electric field on the lateral electric field used for a display function.

Then, according to an embodiment of the invention, in a method for driving the display device with the aforementioned configuration, a display function is performed by controlling the liquid crystal layer by use of the electric field produced between the pixel electrode and first common electrode. In addition, switching between display modes during display is performed on the basis of the electrical potential of the second common electrode.

As described in the configuration of the display device, in the driving method, switching between display modes is performed by giving an effect of the vertical electric field on the lateral electric field used for a display function. Therefore, by using the lateral electric field which is parallel to the electrode plane, a display function is performed in a wide viewing angle peculiar to the lateral electric field mode. On the other hand, by giving an effect of the vertical electric field on the lateral electric field, a display function is performed in a narrow viewing angle in which a contrast in an oblique direction within viewing angle is lower than in a frontal direction within viewing angle.

As described above, according to an embodiment of the invention, a display device is capable of performing switching between display modes during display while the device configuration including a single liquid crystal layer is simple. In addition, in the display device, switching between display modes is performed on the basis of the electrical potential of the second common electrode placed opposite the first common electrode across the liquid crystal layer. Therefore, a high-definition image can be displayed with a pixel aperture sustained.

### BRIEF DESCRIPTION OF THE DRAWINGS

FIGS. 1A and 1B are diagrams illustrating a configuration example of a display device according to a first embodiment of the present invention;

FIG. 2 is a circuit-configuration diagram of the display device;

FIGS. 3A and 3B are diagrams illustrating basic operations of a black display and a white display in a lateral electric field mode, respectively;

FIGS. 4A and 4B are diagrams illustrating a display function in a wide viewing angle mode according to the first embodiment of the present invention;

FIGS. 5A and 5B are diagrams illustrating a display function in a narrow viewing angle mode according to the first embodiment of the present invention;

FIGS. 6A to 6C are graphic diagrams illustrating transmittance and contrast with respect to the electrical potential of the second common electrode in a frontal direction within viewing angle;

FIGS. 7A to 7I are diagrams illustrating a simulation result of viewing angle characteristics in the display device according to the first embodiment;

FIGS. 8A to 8I are diagrams illustrating an observation result of viewing angle characteristics in the display device according to the first embodiment;

FIGS. 9A and 9B are diagrams illustrating a simulation result of an electrical potential among the pixel electrode, first common electrode, and second common electrode during the white display in the wide viewing angle mode;

FIGS. 10A and 10B are diagrams illustrating the structure of a display device according to a second embodiment;

FIG. 11 is a diagram illustrating the structure of a display device according to a third embodiment;

FIG. 12 is a diagram illustrating the basic operation of the display device according to the third embodiment;

FIG. 13 is a diagrammatic perspective view schematically showing a laptop computer to which a display device according to an embodiment of the present invention is applied;

FIG. 14 is a diagrammatic perspective view schematically showing a video camera to which a display device according to an embodiment of the present invention is applied;

FIG. 15 is a diagrammatic perspective view schematically showing a television device to which a display device according to an embodiment of the present invention is applied;

FIGS. 16A and 16B are diagrammatic perspective views schematically showing a digital camera to which a display device according to an embodiment of the present invention is applied;

FIG. 16A showing a front perspective view; and

FIG. 16B showing a rear perspective view;

FIGS. 17A to 17G are diagrams schematically showing a mobile terminal device to which a display device according to an embodiment of the present invention is applied;

FIG. 17A showing a front view of an unfolded mobile terminal device;

FIG. 17B a side view of the unfolded mobile terminal device;

FIG. 17C a front view of a folded mobile terminal device;

FIG. 17D a left side view of the folded mobile terminal device;

FIG. 17E a right side view of the folded mobile terminal device;

FIG. 17F a top view of the folded mobile terminal device; and

FIG. 17G a bottom view of the folded mobile terminal device.

### DESCRIPTION OF THE PREFERRED EMBODIMENTS

Hereinafter, preferred embodiments of the present invention will be described.

### First Embodiment

A first embodiment is an example in which a second common electrode is a blanket layer.

### Configuration of Display Device

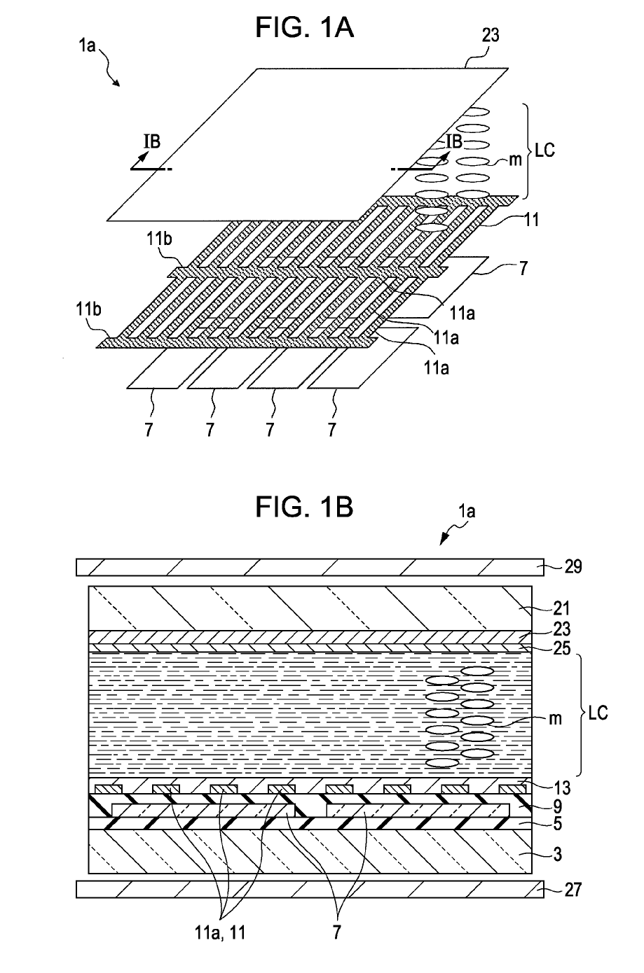

FIG. 1A is a diagrammatic perspective view showing a simple overview of electrodes and a liquid crystal layer in the main section of a display device according to the first embodiment of the present invention. Then, FIG. 1B is a cross-section diagram, taken along IB-IB in FIG. 1A, corresponding to two pixels in the display device according to the first embodiment of the present invention.

In FIGS. 1A and 1B, a fringe field switching (FFS) mode, one of lateral electric field modes, is applied to a display device 1a according to the first embodiment. The configuration will be described.

The display device 1a includes a first substrate 3 with optical transparency. In respective pixels on the first substrate 3, pixel circuits not shown in FIGS. 1A and 1B are arranged in an array. Furthermore, an interlayer insulation layer 5 covering each of the pixel circuits is formed. The interlayer insulation layer 5 is formed with a flat surface, for example.

On the interlayer insulation layer 5, a matrix of pixel electrodes 7, each of which is patterned in the shape of an island and corresponds to a pixel, are arranged in an array. The pixel electrodes 7 include a transparent conductive layer and are connected to a source or a drain of a thin-film transistor included in a pixel circuit through a connecting hole formed in the interlayer insulation layer 5.

On the interlayer insulation layer 5 on which the pixel electrodes 7 are arranged, an insulation layer 9 which covers the pixel electrodes 7 is formed. Then, a first common electrode 11 is arranged on the insulation layer 9. The first common electrode 11 is a comb-like electrode in which a plurality of comb-teeth shaped electrodes 11a are arranged at intervals. Then, the first common electrode 11 has a structure in which the comb-teeth shaped electrodes 11a are arranged for each of the pixel electrodes 7. In this case, for example, the comb-teeth shaped electrodes 11a are arranged so as to extend along the longitudinal directions of the pixel electrodes 7.

In addition, since the comb-teeth shaped electrodes 11a are connected to one another with a bridge electrode 11b between the pixel electrodes 7, the structure retains strength. Therefore, while the first common electrode 11 is a comb-like electrode including a plurality of comb-teeth shaped electrodes 11a, slit apertures between the comb-teeth shaped electrodes 11a have a closed-end type structure.

The first common electrode 11 is continuously formed as a common electrode used for each of the pixel electrodes 7 and is supplied with a common voltage. Then, when a difference of electrical potential between the pixel electrode 7 and the first common electrode 11 is set, an electric field, namely a lateral electric field, is produced, the electric field being perpendicular to the direction in which the comb-teeth shaped electrodes 11a are arranged so as to extend and being parallel to electrode planes of the pixel electrode 7 and the first common electrode 11. A display function is performed by controlling the liquid crystal layer by using switching of the lateral electric field, as described below.

As described above, on the insulation layer 9 on which the first common electrode 11 is arranged, an oriented layer 13 covering the first common electrode 11 is formed. An orientation axis (for example, a rubbing process direction) of the oriented layer 13 is set to a direction which is nearly parallel to the direction in which the comb-teeth shaped electrodes 11a included in the first common electrode 11 are arranged so as to extend. In addition, it is desirable for the orientation axis of the oriented layer 13 to be tilted at some degrees relative to the direction in which the comb-teeth shaped electrodes 11a are arranged so as to extend so that rotational directions of liquid crystal molecules as described below may be aligned.

As described above, the part above the first substrate 3 is structured.

On the other hand, a second substrate 21 is placed opposite one side, on which the oriented layer 13 is formed, of the first substrate 3. The second substrate 21 includes light transmissive material. Then, a second common electrode 23 is arranged on a surface, facing the oriented layer 13, of the second substrate 21. In this case, the second common electrode 23 is formed, as a common electrode used for each of the pixel electrodes 7, in the form of a blanket layer.

In addition, the second common electrode 23 is voltage-controlled independently of the first common electrode 11 and in a stepwise fashion in the range between a drive voltage of the pixel electrode 7 and that of the first common electrode 11. Then, when a display function is performed by voltage-controlling the pixel electrode 7 and first common electrode 11, switching between display modes is performed by voltage-controlling the second common electrode 23.

In addition, between the second substrate 21 and second common electrode 23, color filters used for individual colors, not shown in FIGS. 1A and 1B, are arbitrarily arranged in a pattern and a black matrix corresponding to the pixel spacing is arranged.

Then, an oriented layer 25 covering the second common electrode 23 is formed. An orientation axis (for example, a rubbing process direction) of the oriented layer 25 is set to a direction which is antiparallel to the orientation axis of the oriented layer 13 formed over the first substrate 3.

As described above, the part on the inside of the second substrate 21 is structured.

Between the oriented layer 13 near the first substrate 3 and the oriented layer 25 near the second substrate 21, a spacer, not shown in FIGS. 1A and 1B, is sandwiched and the liquid crystal layer LC is sealed in the space provided by the spacer. The liquid crystal layer LC includes liquid crystal molecules m with positive dielectric anisotropy. In this case, for example, under the condition that a difference of electrical potential is produced between the pixel electrode 7 and first common electrode 11, the layer thickness of the liquid crystal layer LC (namely, cell gap g) is set so that the liquid crystal layer LC may have a phase difference of λ/2.

In addition, on the outside of the first substrate 3, an incident-side polarizing plate 27 is arranged. On the outside of the second substrate 21, an emergent-side polarizing plate 29 is arranged. The incident-side polarizing plate 27 is arranged so that its transmission axis may be perpendicular (or parallel) to the orientation axes of the oriented layers 13 and 25. On the other hand, the emergent-side polarizing plate 29 is arranged so that its transmission axis may be parallel (or perpendicular) to the orientation axes of the oriented layers 13 and 25 and be in a cross-nicol relationship with the incident-side polarizing plate 27. Then, when the transmission axes of the polarizing plates 27 and 29 are in a cross-nicol relationship with each other, it makes no difference whether either of the transmission axes is perpendicular or parallel to the orientation axes of the oriented layers 13 and 25.

Furthermore, the display device 1a includes a backlight source, not shown in FIGS. 1A and 1B, arranged on the outside of the incident-side polarizing plate 27.

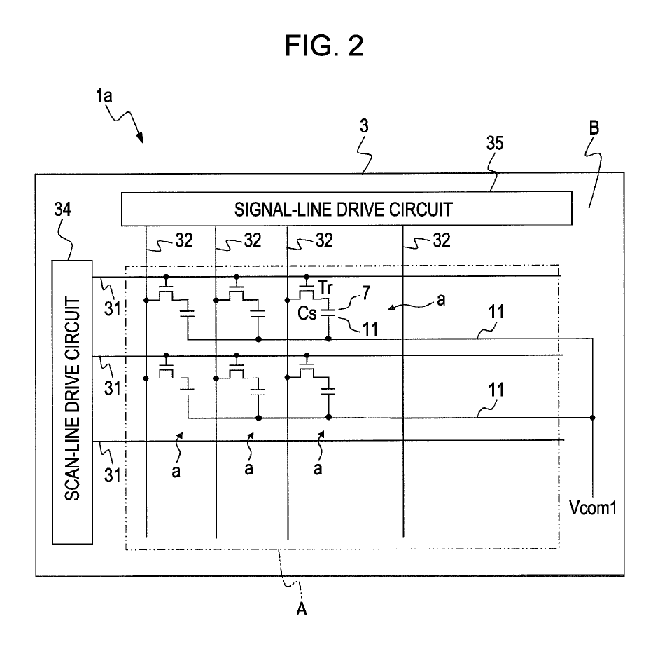

FIG. 2 shows a circuit configuration example of a display device 1a. As shown in FIG. 2, in the display device 1a, a display region A and its neighboring region B are arranged. The display region A includes a picture-element array section, in which a plurality of scan lines 31 and a plurality of signal lines 32 are arranged in a matrix and a pixel a is arranged corresponding to each of portions where the scan lines 31 and signal lines 32 cross. In the pixel a, for example, a thin-film transistor used as a switching element is arranged. In the thin-film transistor Tr, a gate is connected to the scan line 31, one of a source and a drain is connected to the signal line 32, and the other of the source and drain is connected to the pixel electrode 7. Then, a retention capacitor Cs is formed between the pixel electrode 7 and first common electrode 11. A common voltage Vcom1 is applied to the first common electrode 11.

On the other hand, the neighboring region B includes a scan-line drive circuit 34 used for driving the scan line 31, a signal-line drive circuit 35 used for supplying the signal line 32 with a video signal (namely an input signal) corresponding to luminance information, and a drive circuit arranged as necessary.

As described above, the video signal written from the signal line through the thin-film transistor Tr is retained in the retention capacitor Cs between the pixel electrode 7 and first common electrode 11. A voltage according to the retained signal quantity is supplied to the pixel electrode 7. Accordingly, a display function is performed by controlling the liquid crystal layer. The second common electrode 23 included in the first embodiment is not shown in FIG. 2. However, aside from the common voltage Vcom1 applied to the first common electrode 11, the second common electrode 23 is supplied with a voltage switched in a stepwise fashion.

Since the configuration of the pixel circuit described above is just an example, the pixel circuit may include a capacitative element as necessary and furthermore a plurality of transistors. In addition, a necessary drive circuit may be added to the neighboring region B in response to modification of the pixel circuit.

### Display-Device Driving Method

Next, a driving method used for the display device 1a with the above-mentioned configuration will be described with reference to FIGS. 1A and 1B and other figures as necessary.

### 1. Basic Operation

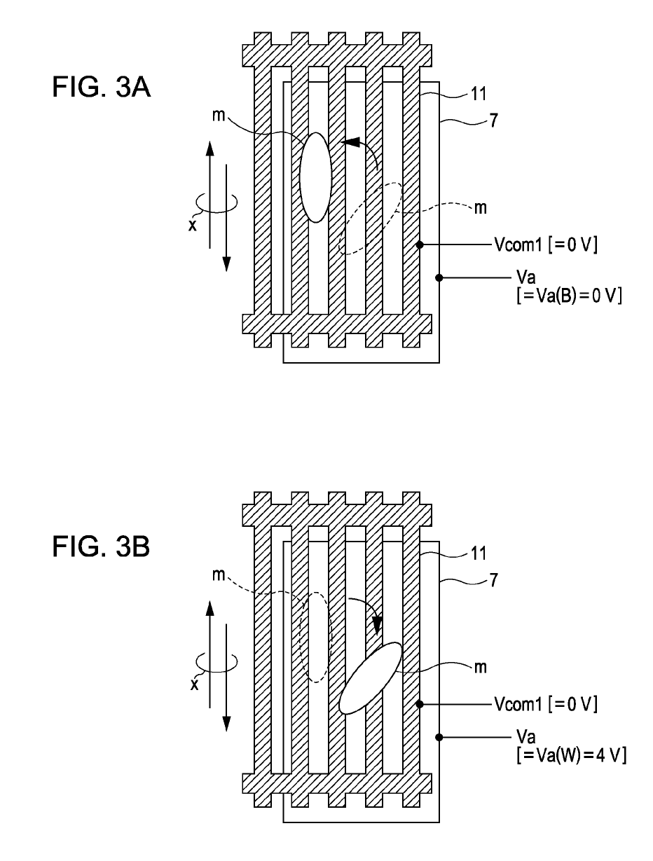

FIG. 3A is a planar diagram illustrating black display in the display device 1a. FIG. 3B is a planar diagram illustrating white display in the display device 1a.

First, in the case of black display shown in FIG. 3A, the electrical potential of the pixel electrode 7, Va, is set to an electrical potential Va(B) (for example 0 V) which is the same as that of the first common electrode 11, Vcom1 (for example 0 V). Therefore, long axes of the liquid crystal molecules m included in the liquid crystal layer LC are oriented parallel to orientation axis directions x of the oriented layers 13 and 25. In this case, incident light passing through the incident-side polarizing plate 27 passes through the liquid crystal layer LC with no change, the incident-side polarizing plate 27 being arranged so that its transmission axis may be perpendicular (or parallel) to the orientation axis directions x of the oriented layers 13 and 25. However, a display function turns to a black-display status since the incident light is interrupted by the emergent-side polarizing plate 29, the emergent-side polarizing plate 29 being arranged so that its transmission axis is in a cross-nicol relationship with the incident-side polarizing plate 27. Namely, the display device 1a is driven in a normally-black status.

On the other hand, in the case of white display shown in FIG. 3B, the electrical potential of the pixel electrode 7, Va, is set to an electrical potential Va(W) (for example 4 V) which is different from that of the first common electrode 11, Vcom1 (for example 0 V). Therefore, since a lateral electric field, which is perpendicular to the direction in which the comb-teeth shaped electrodes 11a are arranged so as to extend and is nearly parallel to electrode planes of the pixel electrode 7 and the first common electrode 11, is produced, long axes of the liquid crystal molecules m are oriented parallel to a direction along the lateral electric field and the liquid crystal layer LC has a phase difference of λ/2. In this case, when incident light, passing through the incident-side polarizing plate 27 which is arranged so that its transmission axis may be perpendicular (or parallel) to the orientation axis directions x of the oriented layers 13 and 25, passes through the liquid crystal layer LC with a phase difference of λ/2, the incident light is rotated by 90 degrees. Accordingly, the incident light reaches and passes through the emergent-side polarizing plate 29. Therefore, a display function turns to a white-display status.

The above-mentioned operation is a basic operation performed in a driving method used for the first embodiment. A display function is performed by changing, between Va(B) (=Vcom1: black display) and Va(W) (white display), the electrical potential of the pixel electrode 7, Va, with respect to the common electrical potential of the first common electrode 11, Vcom1. The basic operation is similar to a display operation of the related art.

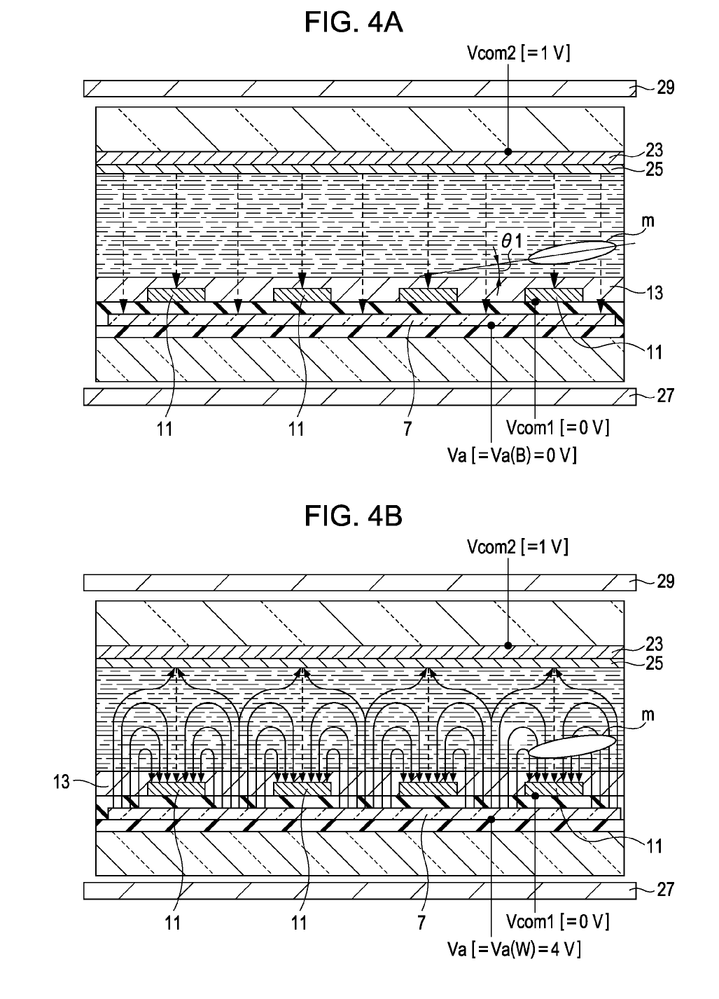

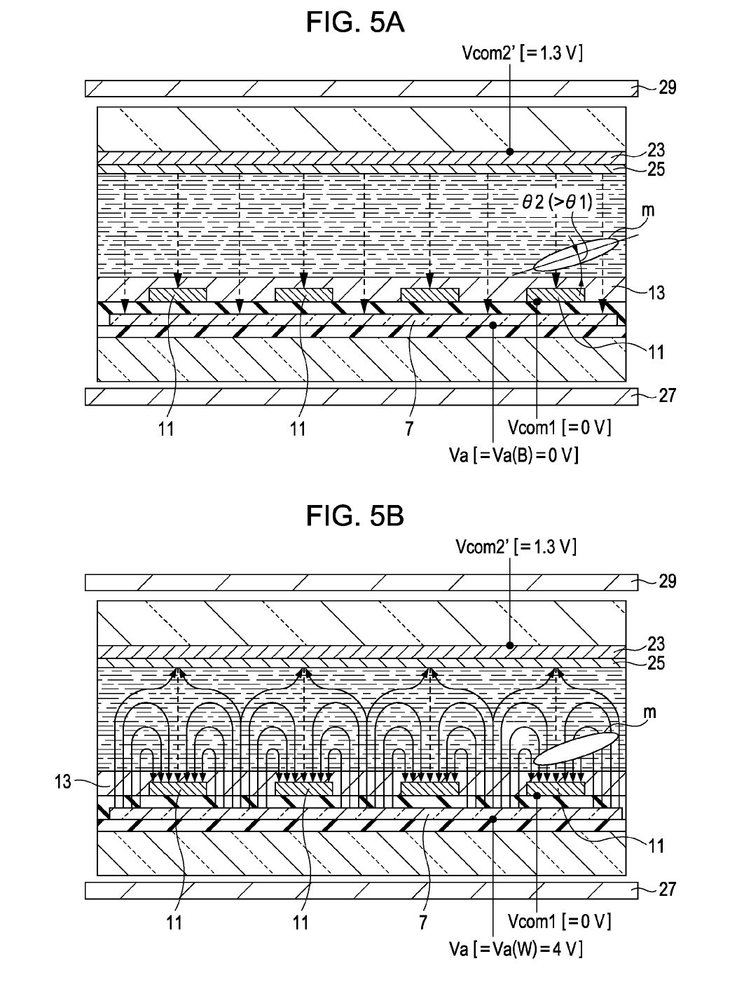

Then, in addition to the basic operation, in a driving method according to an embodiment of the present invention, switching between display modes is performed by controlling the electrical potential of the second common electrode 23. The switched display modes are related to viewing angle characteristics. The driving method in which switching between display modes is performed will be described with reference to FIGS. 3A and 3B and cross-section diagrams corresponding to one pixel, shown in FIGS. 4A, 4B, 5A, and 5B. Directions of induced electric field are indicated by arrows in FIGS. 4A, 4B, 5A, and 5B.

### 2. Wide Viewing Angle Mode

First, display operation in a wide viewing angle mode will be described with reference to FIGS. 3A, 3B, 4A, and 4B. FIG. 4A is a cross-section diagram illustrating a black display, and a planar diagram from which the cross-section diagram is derived corresponds to FIG. 3A. In addition, FIG. 4B is a cross-section diagram illustrating a white display, and a planar diagram from which the cross-section diagram is derived corresponds to FIG. 3B.

During display in the wide viewing angle mode, the electrode 7 and first common electrode 11 are voltage-controlled in the same way as in the basic operation. At the same time, during both the black display and white display, the second common electrode 23 is supplied with a common electrical potential Vcom2 different from the common electrical potential of the first common electrode 11, Vcom2. The common electrical potential Vcom2 is set to an electrical potential value between the electrical potential of the pixel electrode 7 during the white display, Va(W) (for example 4 V), and the electrical potential of the first common electrode 11, Vcom1 (for example 0 V), the electrical potential value not affecting the black display and white display performed by voltage-controlling the pixel electrode 7 and first common electrode 11. Namely, between the pixel electrode 7 and first common electrode 11 and the second common electrode 23, a vertical electric field perpendicular to the electrode plane is produced by applying a voltage to the second common electrode 23.

In this way, orientational states of the liquid crystal molecules m are controlled, so that azimuth directions of the liquid crystal molecules m correspond to the basic operation during the black display as shown in FIG. 3A and that during the white display as shown in FIG. 3B.

On the other hand, during the black display as shown in FIG. 4A, angles (polar angles) of the liquid crystal molecules m with respect to the electrode plane are obliquely inclined at an angle of θ1 degrees on the basis of the effect of a faint vertical electric field. The electrical potential of the second common electrode 23, Vcom2, is set to such a voltage (for example, 1 V) that the produced vertical electric field is so faint as to retain the angle of θ1 degrees at a sufficiently-small value. Therefore, the black display in which transmittance is low over a wide range of viewing angle is performed with limited influence of the polar-angle directional inclination (the angle θ1) of the liquid crystal molecules, the polar-angle directional inclination being caused by the vertical electric field.

On the other hand, during the white display as shown in FIG. 4B, angles (polar angles) of the liquid crystal molecules m with respect to the electrode plane are obliquely inclined on the basis of the effect of a faint vertical electric field. However, the inclination of the liquid crystal molecules during the white display, which is also affected by the lateral electric field, is smaller than the inclination (the angle θ1) during the black display. Therefore, the white display in which transmittance is high over a wide range of viewing angle is performed with limited influence of the electrical potential of the second common electrode 23.

Therefore, display in the wide viewing angle mode with a wide viewing angle and a sufficiently-high contrast is performed.

In addition, in the wide viewing angle mode, since the second common electrode 23 to which a voltage is applied transits from a floating state, effects among neighboring pixels on display are prevented.

### 3. Narrow Viewing Angle Mode

Display operation in a narrow viewing angle mode will be described with reference to FIGS. 3A, 3B, 5A, and 5B. FIG. 5A is a cross-section diagram illustrating a black display, and a planar diagram from which the cross-section diagram is derived corresponds to FIG. 3A. In addition, FIG. 5B is a cross-section diagram illustrating a white display, and a planar diagram from which the cross-section diagram is derived corresponds to FIG. 3B.

During display in the narrow viewing angle mode, the electrode 7 and first common electrode 11 are voltage-controlled in the same way as in the basic operation. At the same time, during both the black display and white display, the second common electrode 23 is supplied with a common electrical potential Vcom2′ different from the common electrical potential of the first common electrode 11, Vcom1 and the common electrical potential of the second common electrode 23, Vcom2, in the wide viewing angle mode. In the same way as in the wide viewing angle mode, the common electrical potential Vcom2′ is set to an electrical potential value between the electrical potential of the pixel electrode 7, Va(W) (for example 4 V) and the electrical potential of the first common electrode 11, Vcom1 (for example 0 V). In addition, the common electrical potential Vcom2′ is set so that a difference of electrical potential between the pixel electrode 7 (and the first common electrode 11) and the common electrical potential Vcom2′ may be larger than during the black display in the wide viewing angle mode. Between the pixel electrode 7 and first common electrode 11 and the second common electrode 23, a vertical electric field is produced by applying the common electrical potential Vcom2′ to the second common electrode 23, the vertical electric field being stronger than in the wide viewing angle mode. However, the common electrical potential of the second common electrode 23, Vcom2′, is set in a range which does not affect a viewing angle in a frontal direction during the black display and white display performed by voltage-controlling the pixel electrode 7 and first common electrode 11.

Therefore, in the same way as in the wide viewing angle mode, orientational states of the liquid crystal molecules m are controlled, so that azimuth directions of the liquid crystal molecules m correspond to the basic operation during the black display as shown in FIG. 3A and that during the white display as shown in FIG. 3B.

On the other hand, during the black display as shown in FIG. 5A, angles (polar angles) of the liquid crystal molecules m with respect to the electrode plane are obliquely inclined at an angle of θ2 degrees on the basis of the effect of a faint vertical electric field. The angle θ2 is a larger angle (>0θ1) than in the wide viewing angle mode. In this case, the electrical potential of the second common electrode 23, Vcom2′, is set to an electrical potential value (for example 1.3 V) in the range in which the polar-angle (the angle θ2) of the liquid crystal molecules during the black display does not affect an anterior field of view.

Accordingly, for the anterior field of view, the black display in which transmittance is low is performed with limited influence of the polar-angle directional inclination (the angle θ2) of the liquid crystal molecules, the polar-angle directional inclination being caused by the vertical electric field. However, since transmittance for an oblique field of view, out of the anterior field of view, is increased by influence of the polar-angle directional inclination (the angle θ2) of the liquid crystal molecules, display in which contrast is low is performed.

On the other hand, during the white display as shown in FIG. 5B, angles (polar angles) of the liquid crystal molecules m with respect to the electrode plane are obliquely inclined on the basis of the effect of the vertical electric field. The inclination of the liquid crystal molecules, which is also affected by the lateral electric field, is smaller than the inclination (the angle θ2) during the black display.

Therefore, for the anterior field of view, the white display in which transmittance is high is performed with limited influence of the polar-angle directional inclination of the liquid crystal molecules, the polar-angle directional inclination being caused by the vertical electric field. Therefore, for the anterior field of view, display in which contrast is sufficiently-high is performed in combination with the black display. However, since transmittance for the oblique field of view, out of the anterior field of view, is decreased by the influence of the polar-angle directional inclination of the liquid crystal molecules, display in which contrast is low is performed in combination with increased transmittance during the black display.

Therefore, while display in which contrast is high can be performed for the anterior field of view, display is performed in a narrow viewing angle mode in which contrast is reduced for the oblique field of view.

### 4. Voltage Setting of Second Common Electrode

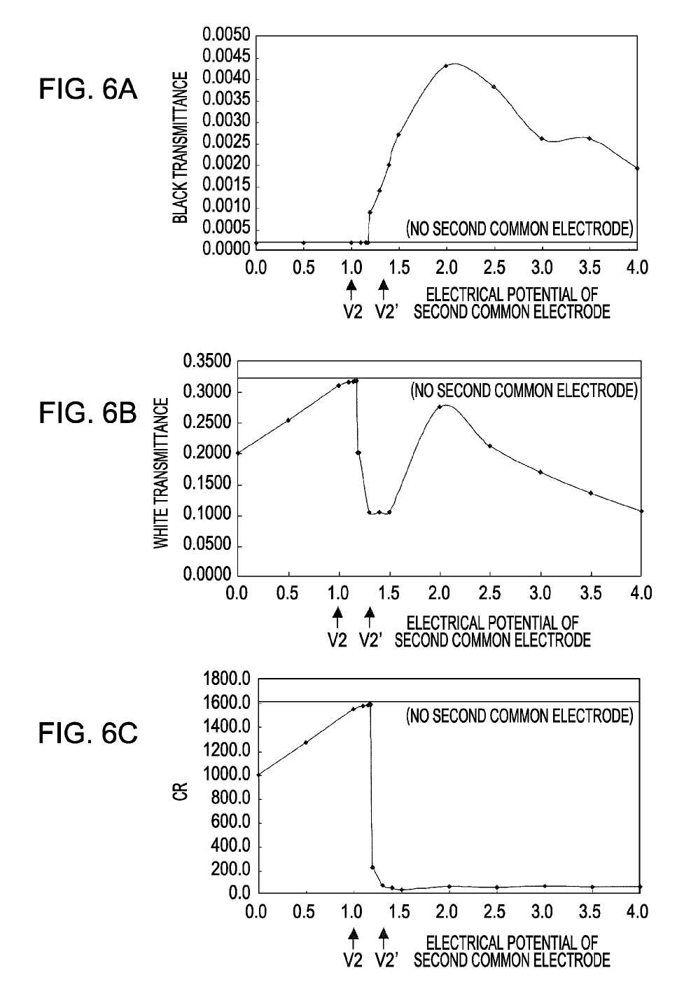

As described below, the common electrical potentials of the second common electrode 23, Vcom2 and Vcom2′, are set with reference to, for example, measured values shown in FIGS. 6A to 6C, the Vcom2 and Vcom2′ being used for performing switching between the above-mentioned wide viewing angle mode and narrow viewing angle mode. FIGS. 6A to 6C are graphic diagrams illustrating transmittance and contrast with respect to the electrical potential of the second common electrode in an oblique direction within a viewing angle. FIG. 6A illustrates transmittance during a black display. FIG. 6B illustrates transmittance during a white display. FIG. 6C illustrates contrast.

First, the common electrical potential of the second common electrode 23, Vcom2, used for switching to the wide viewing angle mode, is set to an electrical potential value which does not affect the black display and white display performed by voltage-controlling the pixel electrode 7 and first common electrode 11. Therefore, an electrical potential value, equal to 1 V, is selected for the common electrical potential of the second common electrode 23, Vcom2, so that transmittance may be low during the black display and high during the white display and contrast may be favorable.

Then, the common electrical potential of the second common electrode 23, Vcom2′, used for switching to the narrow viewing angle mode, is set in a range so that a difference of electrical potential between the second common electrode 23 and the pixel electrode 7 (and the first common electrode 11) may be larger than during the black display in the wide viewing angle mode. However, the common electrical potential of the second common electrode 23, Vcom2′, is set in a range which does not affect a viewing angle in a frontal direction during the black display and white display performed by voltage-controlling the pixel electrode 7 and first common electrode 11. Therefore, an electrical potential value, equal to 1.3 V, is selected for the common electrical potential, Vcom2′, in a range which is larger than an electrical potential value, equal to 1 V, selected for the common electrical potential, Vcom2. While front-directional contrast decreases to about 50 if the common electrical potential, Vcom2′, is equal to 1.3 V, the contrast is retained in a favorable range.

The above-mentioned common electrical potentials, Vcom2 and Vcom2′, applied to the second common electrode, may be set through a simulation. In the simulation, factors are illustrated as below:

(1) intervals of the arranged comb-teeth shaped electrode 11a included in the first common electrode 11;

(2) permittivities of insulation layer and liquid crystal layer LC formed among the pixel electrode 7, first common electrode 11, and second common electrode 23;

(3) driving voltages, Va(B) and Va(W), applied to the pixel electrode 7; and

(4) the common electrical potential of the first common electrode 11, Vcom1.

According to the above-mentioned first embodiment, while a display device adopts a simple configuration in which a single liquid crystal layer is used, switching between display modes during display can be performed by voltage-controlling the second common electrode 23 arranged in in-cell structure. Furthermore, for the purpose of performing switching between display modes, an element used for display-mode switching is not arranged in parallel with the pixel array. This is because the second common electrode 23 is placed opposite the first common electrode 11 across the liquid crystal layer LC. Therefore, a high-definition image can be displayed while maintaining a pixel aperture.

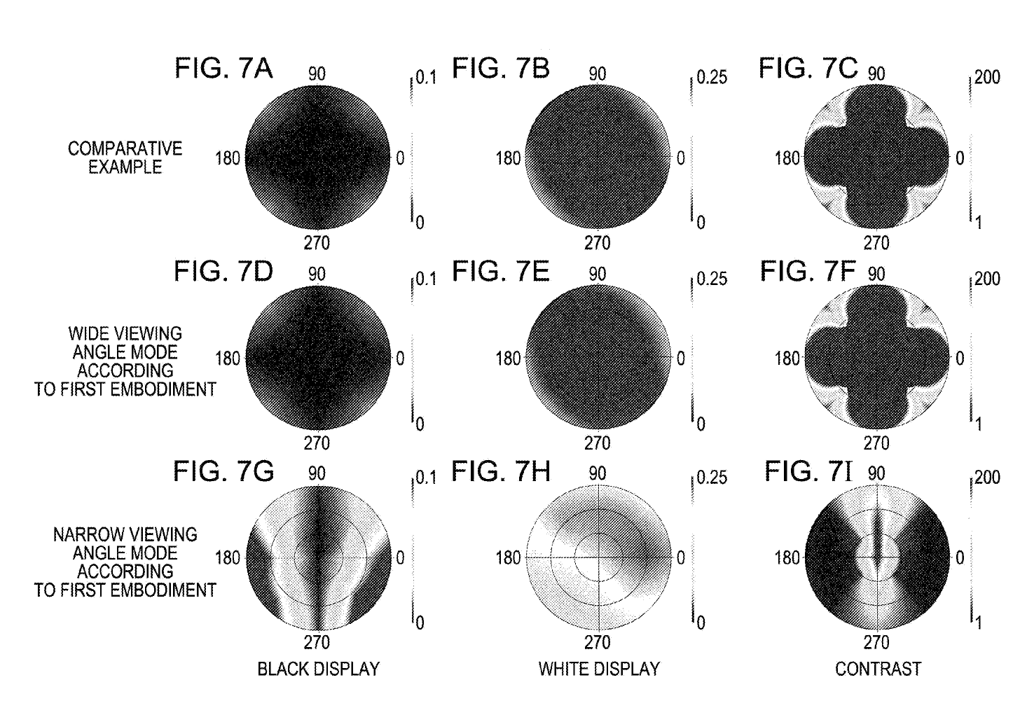

FIGS. 7A to 7I illustrate a simulation result of viewing angle characteristics in the display device 1a designed as described above according to the first embodiment. FIGS. 7A to 7C show comparative examples illustrating viewing angle characteristics of a configuration with no second common electrode. FIGS. 7D to 7F illustrate viewing angle characteristics of the display device 1a in a wide viewing angle mode according to the first embodiment. FIGS. 7G to 7I illustrate viewing angle characteristics of the display device 1a in a narrow viewing angle mode according to the first embodiment.

As shown in FIGS. 7A to 7F, a black display, a white display, and contrast of the display device 1a in a wide viewing angle mode according to the first embodiment, corresponding to FIGS. 7D to 7F, are as favorable to those in a wide viewing angle as comparative examples as shown in FIGS. 7A to 7C. As shown in FIG. 7I in display on the display device 1a in a narrow viewing angle mode according to the first embodiment, while favorable contrast is retained for a viewing angle in a frontal direction, contrast is reduced for a viewing angle in right and left azimuth directions in FIG. 7I. This is because, even during the black display, the display device is in transmissive state in a more oblique direction than a polar angle of 30 degrees in right and left azimuth directions. Therefore, the contrast approaches unity.

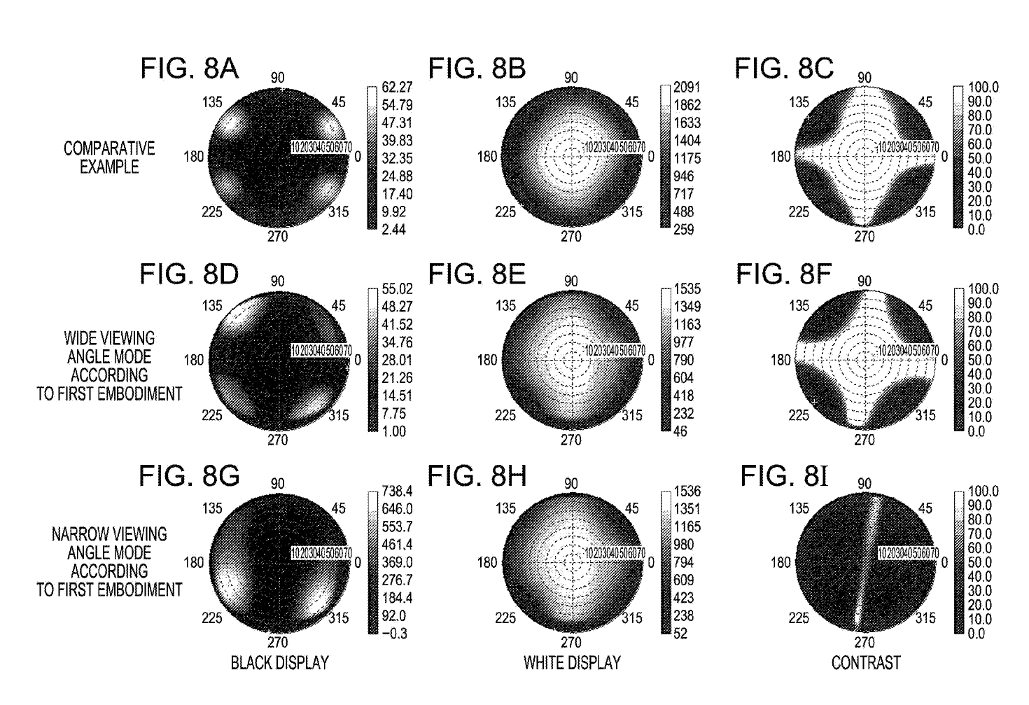

FIGS. 8A to 8I illustrate an observation result of viewing angle characteristics in the display device 1a designed as described above according to the first embodiment. FIGS. 8A to 8C show comparative examples illustrating viewing angle characteristics of a configuration with no second common electrode. FIGS. 8D to 8F illustrate viewing angle characteristics of the display device 1a in a wide viewing angle mode according to the first embodiment. FIGS. 8G to 8I illustrate viewing angle characteristics of the display device 1a in a narrow viewing angle mode according to the first embodiment.

As shown in FIGS. 8A to 8F, it is recognized that a black display, a white display, and contrast of the display device 1a in a wide viewing angle mode according to the first embodiment, corresponding to FIGS. 8D to 8F, are as favorable to those in a wide viewing angle as comparative examples as shown in FIGS. 8A to 8C. It is recognized that, as shown in FIG. 8I, in display on the display device 1a in a narrow viewing angle mode according to the first embodiment, while favorable contrast is retained for a viewing angle in a frontal direction, contrast is reduced for a viewing angle in right and left azimuth directions in FIG. 8I.

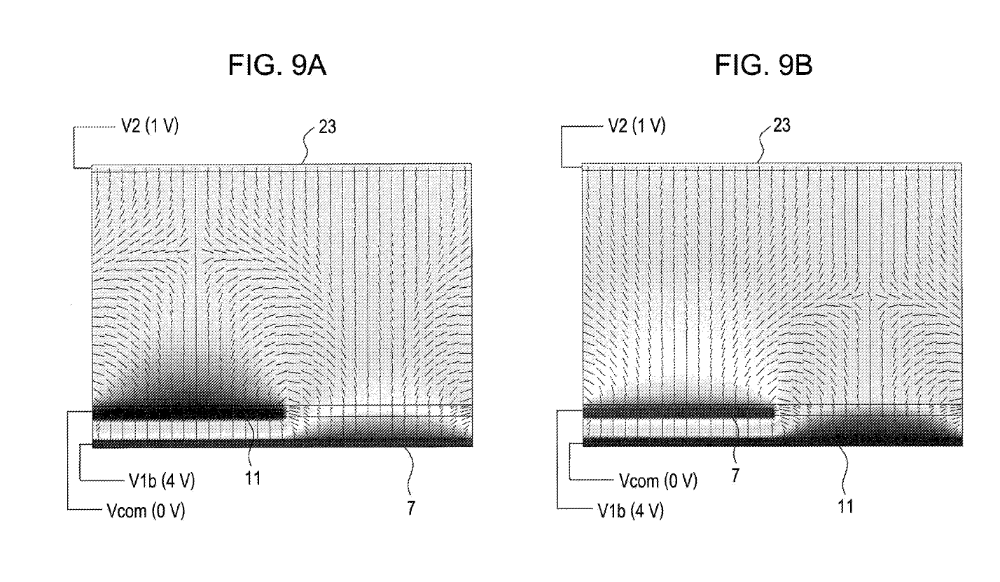

In addition, in the display device 1a according to the first embodiment of the invention, the first common electrode 11 is arranged at one side of the pixel electrode 7, the side facing the liquid crystal layer LC. Therefore, it is possible to reduce an effect of the electrical potential of the second common electrode 23 in the wide viewing angle mode. FIG. 9A illustrates a simulation result of an electrical potential among the pixel electrode 7, first common electrode 11, and second common electrode 23 during the white display in the wide viewing angle mode. Then, FIG. 9B illustrates a simulation result of a configuration in which a stacking sequence of the pixel electrode 7 and first common electrode 11 is inverted by way of comparison.

As shown in FIGS. 9A and 9B, the configuration of the display device 1a according to the first embodiment, corresponding to FIG. 9A, results in both a wide interval between the pixel electrode 7 and second common electrode 23 and shielding effectiveness of the first common electrode 11. Therefore, it is confirmed that the effect of a vertical electric field on a lateral electric field used for a display function is reduced, the vertical electric field being caused by a difference of electrical potential between the pixel electrode 7 and second common electrode 23, the lateral electric field being caused by a difference of electrical potential between the pixel electrode 7 and first common electrode 11.

Therefore, by applying a voltage to the second common electrode 23 in the wide viewing angle mode, a wide-viewing angle display is performed with the effect of the vertical electric field reduced, while the effect among neighboring pixels on display is prevented.

In addition, since the second common electrode 23 is placed opposite the pixel electrode 7 and first common electrode 11 used for the display function in a lateral electric field mode of the related art, residual electric charge at the second substrate 21 is prevented. Therefore, liquid crystal malfunctions such as burn-in can be prevented.

In addition, during the black display with no difference of electrical potential produced between the pixel electrode 7 and first common electrode 11, the vertical electric field is produced. Therefore, the combination of orientation restraining force of the liquid crystal molecules m caused by the oriented layers 13 and 25 and orientation restraining force caused by the vertical electric field strengthens orientation restraining force. Accordingly, a bleeding malfunction which arises when a surface of a display is pressed is suppressed.

In addition, the common electrical potentials, Vcom2 and Vcom2′, applied to the second common electrode, may be set to a larger number of multiple levels than the two levels in the wide viewing angle mode and narrow viewing angle mode. In this case, for example, an intermediate electrical potential may be set between the common electrical potentials, Vcom2 and Vcom2′. Therefore, switching between display modes may be performed in multiple viewing angles including intermediate viewing angle characteristics located between those of the wide viewing angle mode and narrow viewing angle mode.

### Second Embodiment

A second embodiment is an example that a second common electrode is a comb-like electrode.

Configuration of Display device

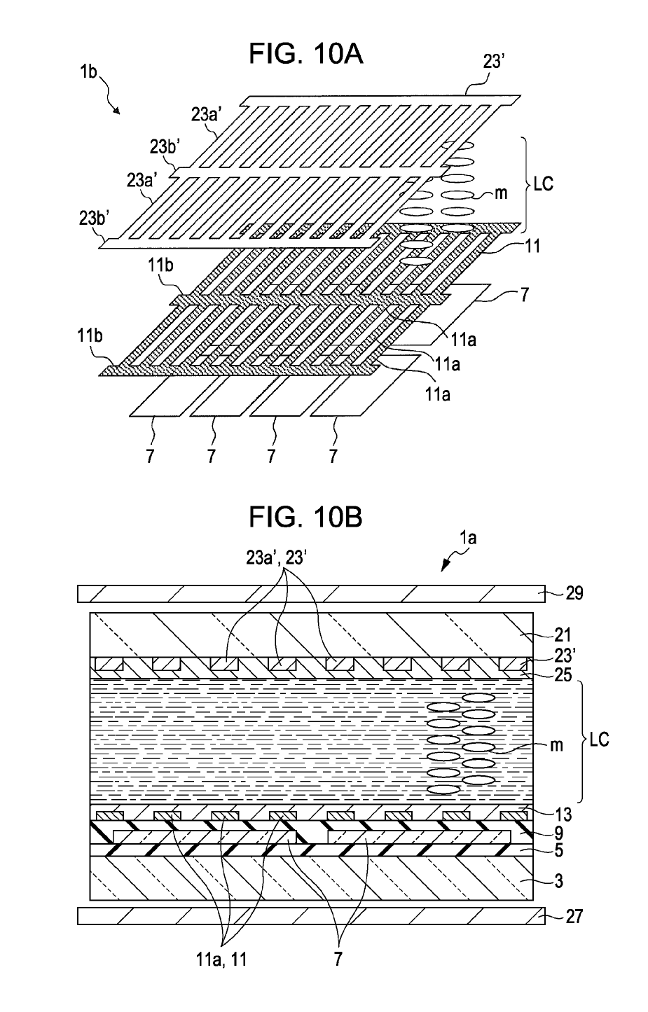

FIG. 10A is a diagrammatic perspective view showing a simple overview of electrodes and a liquid crystal layer in the main section of a display device according to a second embodiment of the present invention. Then, FIG. 10B is a cross-section diagram corresponding to two pixels in the display device according to the second embodiment of the present invention. In FIGS. 10A and 10B, in the same way as the display device 1a according to the first embodiment, Fringe field switching (FFS) mode is also applied to a display device 1b according to the second embodiment.

While the configuration of a second common electrode 23′ in the display device 1b is different from that in the display device 1a according to the first embodiment, other configuration examples correspond to those in the display device 1a.

The second common electrode 23′ is a comb-like electrode similar to the first common electrode 11. In the second common electrode 23′, a plurality of comb-teeth shaped electrodes 23a′ arranged at intervals are connected to one another with bridge electrodes 23b′. Then, the comb-teeth shaped electrodes 23a′ included in the second common electrode 23′ are arranged so as to be placed opposite the comb-teeth shaped electrodes 11a included in the first common electrode 11. Furthermore, the bridge electrodes 23b′ included in the second common electrode 23′ are arranged so as to be placed opposite the bridge electrodes 11 included in the first common electrode 11.

### Display-Device Driving Method

A driving method used for the display device 1b with the above-mentioned configuration is similar to the driving method used for the display device 1a according to the first embodiment of the present invention. Therefore, descriptions of the driving method used for the display device 1a, in which the “second common electrode 23” is replaced with the “second common electrode 23′”, may be applied to the driving method used for the display device 1b.

The above-described second embodiment may also obtain the same advantageous effects as the first embodiment. Namely, while a display device adopts a simple configuration in which a single liquid crystal layer is used, switching between display modes during display can be performed by voltage-controlling the second common electrode 23′ arranged in in-cell structure. Furthermore, for the purpose of performing switching between display modes, an element used for display-mode switching is not arranged in parallel with pixel array. This is because the second common electrode 23′ is placed opposite the first common electrode 11 across the liquid crystal layer LC. Therefore, a high-definition image can be displayed with a pixel aperture sustained.

In addition to the advantageous effects of the first embodiment, the electrode section of the second common electrode 23′ is not arranged at a location directly facing the pixel electrode 7. Therefore, since the lateral electric field and vertical electric field are effectively applied to the liquid crystal layer, it is easy to control the wide viewing angle mode and narrow viewing angle mode.

### Third Embodiment

A third embodiment is an example that a first common electrode is in multidomain structure.

Configuration of Display device

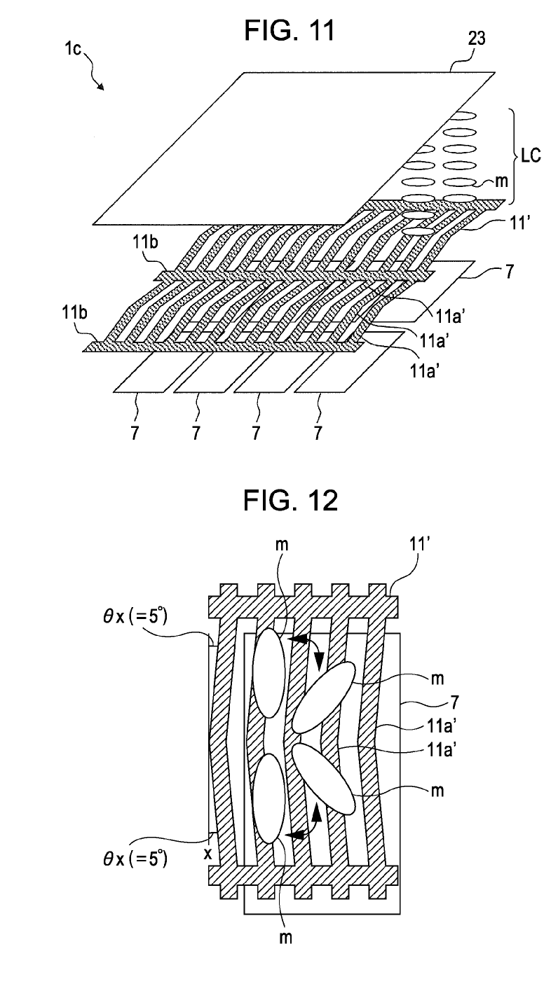

FIG. 11 is a diagrammatic perspective view showing a simple overview of electrodes and a liquid crystal layer in the main section of a display device according to a third embodiment of the present invention. Then, FIG. 12 is a planar diagram corresponding to the main portion of one pixel, illustrating the basic operation of the display device. In FIGS. 11 and 12, in the same way as the display device 1a according to the first embodiment, Fringe field switching (FFS) mode is also applied to a display device 1c according to the second embodiment. Also, the multidomain structure is applied to the display device 1c.

While the configuration of a first common electrode 11′ in the display device 1c is different from that in the display device 1a according to the first embodiment, other configuration examples correspond to those in the display device 1a.

The first common electrode 11′ is a comb-like electrode similar to the first common electrode 11 in the first embodiment. In addition, a plurality of comb-teeth shaped electrodes 11a′ arranged at intervals are inflected in two directions in the middle thereof in a direction in which the plurality of comb-teeth shaped electrodes are arranged so as to extend over the pixel electrodes 7. The comb-teeth shaped electrodes 11a′ are inflected in two directions which are obliquely inclined at a virtually-identical angle of θx with respect to the orientation axis x of an oriented layer not shown in FIGS. 11 and 12. The angle, θx, is about five degrees, for example. Then, in the same way as the first embodiment, the comb-teeth shaped electrodes 11a′ are connected to one another with a bridge electrode 11b between the pixel electrodes 7.

### Display-Device Driving Method

Since a driving method used for the display device 1c with the above-mentioned configuration is similar to the driving method used for the display device 1a according to the first embodiment of the present invention, descriptions of the driving method used for the display device 1a, in which the “first common electrode 11” is replaced with the “first common electrode 11′”, may be applied to the driving method used for the display device 1c.

The above-described third embodiment may also obtain the same advantageous effects as the first embodiment. Namely, while a display device adopts a simple configuration in which a single liquid crystal layer is used, switching between display modes during display can be performed by voltage-controlling the second common electrode 23 arranged in in-cell structure. Furthermore, for the purpose of performing switching between display modes, an element used for display-mode switching is not arranged in parallel with pixel array. This is because the second common electrode 23 is placed opposite the first common electrode 11′ across the liquid crystal layer LC. Therefore, a high-definition image can be displayed with a pixel aperture sustained.

In addition, the display device 1c includes the structure that the comb-teeth shaped electrode 11a′ included in the first common electrode 11′ is inflected at a position corresponding to the middle of the pixel electrode 7. Accordingly, the portion over each pixel electrode 7 is divided into two regions in which the comb-teeth shaped electrode 11a′ is arranged so as to extend in different directions. Therefore, in addition to the advantageous effects of the first embodiment, since the liquid crystal molecules m are driven in different rotation directions in the two regions into which the portion over one pixel electrode 7 is divided, a viewing angle characteristic during halftone or a white display (color shift) is improved.

Then, the third embodiment may be combined with the second embodiment. In this case, corresponding to the first common electrode 11′, the second common electrode may be inflected in the middle thereof in a direction in which the comb-teeth shaped electrode is arranged so as to extend over the pixel electrode 7. Therefore, the advantageous effects of the second embodiment may be added to the third embodiment.

### Examples of Applications of Display Device according to Embodiments of the Present Invention

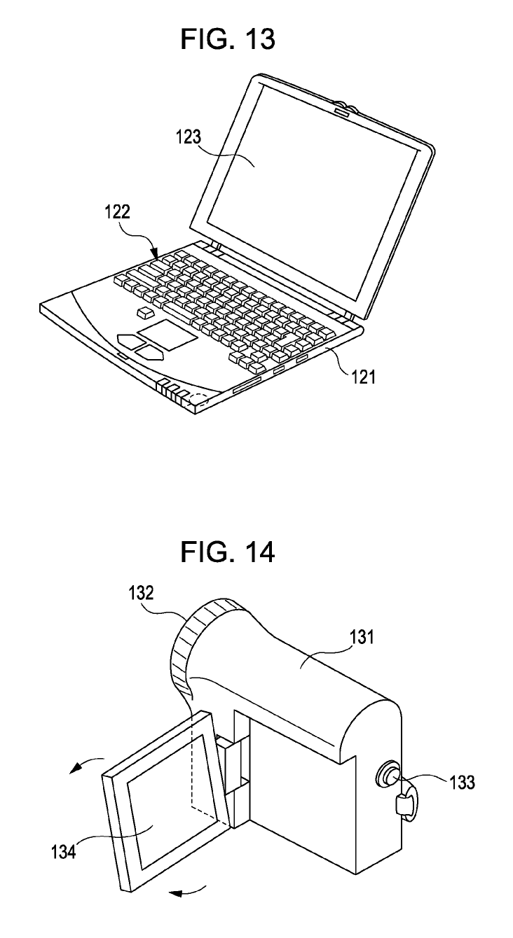

The above-described display devices according to embodiments of the present invention can be applied to a variety of electronic devices shown in FIGS. 13 to 17G. For example, the variety of electronic devices include a digital camera, a laptop computer, a mobile terminal device such as a mobile phone, and a video camera. Namely, the display devices can be applied to display devices included in all kinds of electronic devices for displaying, as a picture image or a video, a video signal input to or generated in an electronic device. Examples of electronic devices to which the display devices are applied will hereinafter be described.

FIG. 13 is a diagrammatic perspective view illustrating a laptop computer, to which a display device according to an embodiment of the present invention is applied. The laptop computer, to which the display device is applied, includes, in a main unit 121, a keyboard 122 operated to input characters and a display section 123 for displaying a picture image. The laptop computer is manufactured by using the display device as the display section 123.

FIG. 14 is a diagrammatic perspective view illustrating a video camera, to which a display device according to an embodiment of the present invention is applied. The video camera, to which the display device is applied, includes a main unit 131, a shooting lens 132 provided on the front face, a start/stop switch 133 for shooting, and a display section 134. The video camera is manufactured by using the display device as the display section 134.

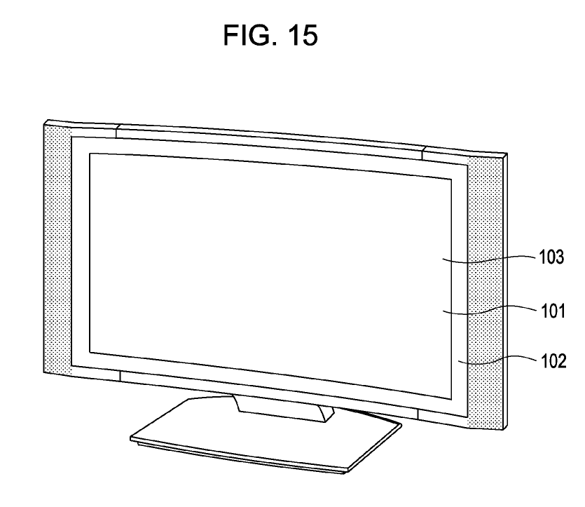

FIG. 15 is a diagrammatic perspective view illustrating a television device to which a display device according to an embodiment of the present invention is applied. The television device, to which the display device is applied, includes a video display screen section 101 including a front panel 102 and a filter glass 103. The television device is manufactured by using the display device as the video display screen section 101.

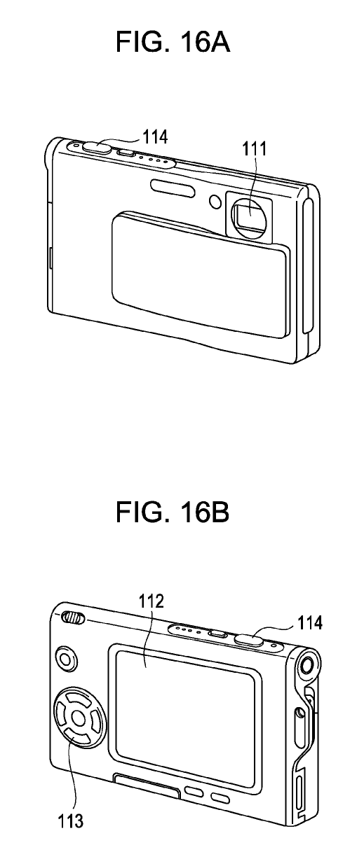

FIGS. 16A and 16B illustrate a digital camera to which a display device according to an embodiment of the present invention is applied. Then, FIG. 16A shows a diagrammatic perspective view from an obverse side, and FIG. 16B shows a diagrammatic perspective view from a reverse side. The digital camera, to which the display device is applied, includes a light-emitting section 111 for photoflash, a display section 112, a menu switch 113, and a shutter button 114. The digital camera is manufactured by using the display device as the display section 112.

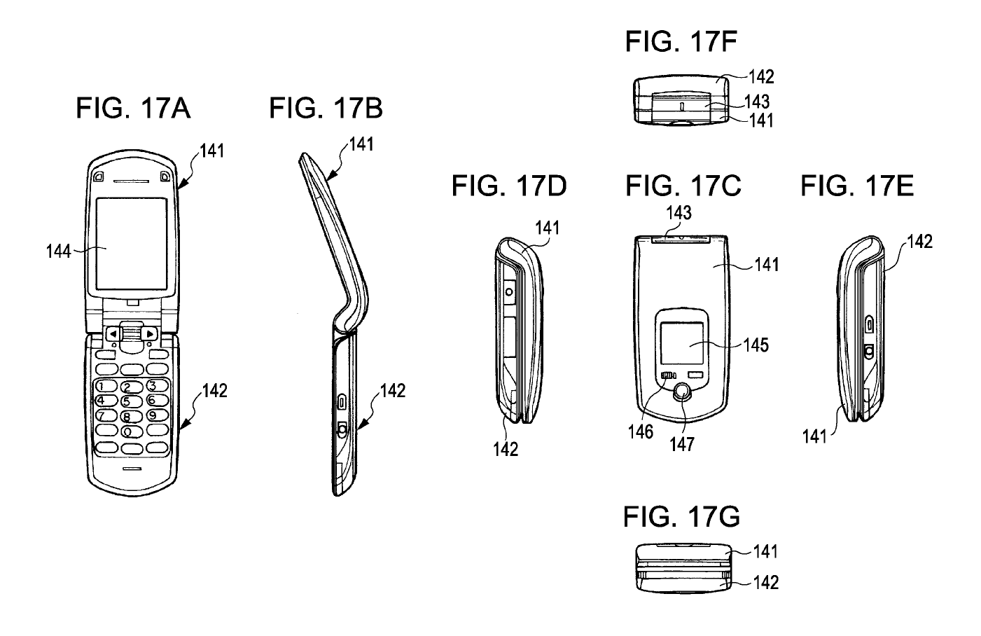

FIGS. 17A to 17G are diagrams illustrating a mobile terminal device such as a mobile phone, to which a display device according to an embodiment of the present invention is applied. FIG. 17A shows a front view of an unfolded mobile terminal device, FIG. 17B a side view of the unfolded mobile terminal device, FIG. 17C a front view of a folded mobile terminal device, FIG. 17D a left side view of the folded mobile terminal device, FIG. 17E a right side view of the folded mobile terminal device, FIG. 17F a top view of the folded mobile terminal device, and FIG. 17G a bottom view of the folded mobile terminal device. The mobile phone, to which the display device is applied, includes an upper chassis 141, a lower chassis 142, a joining section (a hinge section, in this case) 143, a display 144, a sub-display 145, a picture light 146, a camera 147. The mobile phone is manufactured by using the liquid-crystal display device as the display 144 or the sub-display 145.

The present application contains subject matter related to that disclosed in Japanese Priority Patent Application JP 2008-297720 filed in the Japan Patent Office on Nov. 21, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display device comprising:
a plurality of pixel electrodes;
a first common electrode arranged on an insulation layer which covers the plurality of pixel electrodes, the first common electrode being a comb-like electrode; and
a second common electrode placed opposite the first common electrode with a liquid crystal layer therebetween, the second common electrode being voltage-controlled independently of the first common electrode.

2. The display device according to claim 1,
wherein a display function is performed by controlling the liquid crystal layer by use of an electric field produced between the pixel electrode and the first common electrode, and
switching between display modes is performed on the basis of the electrical potential of the second common electrode.

3. The display device according to claim 1,
wherein the display function is performed by controlling the liquid crystal layer by use of an electric field produced between the pixel electrode and the first common electrode, and
switching between orientational states is performed on the basis of the electrical potential of the second common electrode, the orientational states being those of liquid crystal molecules included in the liquid crystal layer relating to the display function.

4. The display device according to any one of claims 1,
wherein the liquid crystal layer includes liquid crystal molecules whose dielectric anisotropy is positive, and
the display function is performed by controlling the liquid crystal layer by use of an electric field produced between the pixel electrode and the first common electrode, the electric field being parallel to an electrode plane of the first common electrode.

5. The display device according to any one of claims 1,
wherein the electrical potential of the second common electrode is controlled in the range between the electrical potential of the first common electrode and the electrical potential of the pixel electrode during a white display.

6. The display device according to any one of claims 1,
wherein a viewing angle characteristic is narrowed by controlling the electrical potential of the second common electrode so that a difference of electrical potential between the first common electrode and the second common electrode may be large during a black display.

7. The display device according to any one of claims 1,
wherein the second common electrode is arranged in a shape of a comb-like electrode corresponding to the first common electrode.

8. The display device according to any one of claims 1,
wherein a plurality of comb-teeth shaped electrodes included in the first common electrode are bent in two directions in the middle thereof in a direction in which the plurality of comb-teeth shaped electrodes are arranged so as to extend over the plurality of pixel electrodes.

9. A driving method for a display device including a first common electrode arranged on an insulation layer which covers the plurality of pixel electrodes, the first common electrode being a comb-like electrode and a second common electrode placed opposite the first common electrode across a liquid crystal layer, comprising the steps of:
performing a display function by controlling the liquid crystal layer by use of an electric field produced between the pixel electrode and the first common electrode; and
performing switching between display modes on the basis of the electrical potential of the second common electrode.

10. The driving method according to claim 9,
wherein an orientational state of liquid crystal molecules included in the liquid crystal layer is controlled on the basis of the electrical potential of the second common electrode when the switching between display modes is performed.

11. The driving method according to claim 9,
wherein the liquid crystal layer includes liquid crystal molecules whose dielectric anisotropy is positive, and
the liquid crystal layer is controlled by use of an electric field produced between the pixel electrode and the first common electrode, the electric field being parallel to an electrode plane of the first common electrode, when the display function is performed.

12. The driving method according to any one of claims 9,
wherein the electrical potential of the second common electrode is controlled in the range between the electrical potential of the first common electrode and the electrical potential of the pixel electrode during a white display when the switching between display modes is performed.

13. The driving method according to any one of claims 9,
wherein a viewing angle characteristic is narrowed by controlling the electrical potential of the second common electrode so that a difference of electrical potential between the first common electrode and the second common electrode may be large during a black display, when the switching between display modes is performed.

14. An electronic device comprising:
a display device;
wherein the display device includes
a plurality of pixel electrodes,
a first common electrode arranged on an insulation layer which covers the plurality of pixel electrodes, the first common electrode being a comb-like electrode, and
a second common electrode placed opposite the first common electrode with a liquid crystal layer therebetween, the second common electrode being voltage-controlled independently of the first common electrode.
